(19) United States
(12) Patent Application Publication
(10) Pub. No.: US 2010/0117541 A1
(43) Pub. Date: May 13, 2010

(54) Lighting Device

(75) Inventors: Richard Landry Gray, Saratoga, CA (US); Po Ming Tsai, Taipei (TW)

Correspondence Address: Richard Landry Gray, 18900 Aspesi Drive, Saratoga, CA, 95070, US

(73) Assignee: Richard Landry Gray, Saratoga, CA (US)

(21) Appl. No.: 12/573,503

(22) Filed: Oct. 5, 2009

Related U.S. Application Data
(60) Provisional application No. 61/199,045, filed on Nov. 13, 2008.

(51) Int. Cl. H05B 37/02; F21V 23/00

(52) U.S. Cl. 315/149; 315/291; 362/260

(57) ABSTRACT

A lighting device having a built-in driver circuitry is provided. The object of the present invention is to provide a lighting device having a built-in driver circuitry for driving the lighting in order to be installed in existing lighting fixtures and for driving the lighting. The lighting device comprises at least one fluorescent lamp and a built-in driver circuitry.

### FIELD OF THE INVENTION

The present invention relates to a lighting device, especially to a lighting device having a built-in driver circuitry.

### BACKGROUND OF THE INVENTION

Lighting technology continues to be pushed by several factors including higher efficiency, longer life, lower environmental impact, and lower cost. At the present time, hot cathode fluorescent lamps (HCFL) and compact fluorescent lamps (CFL) provide the highest performance per cost ratio in the industry. White light emitting diode lighting (WLED) is a promising technology but at this point in time is far from matching the price and performance of both CFL and HCFL lighting.

Standard fluorescent lighting in T-8 or T-5 form factors (or variations thereof which are generally called T-x) is readily available and the fluorescent lighting with electronic ballasting outperforms the old fashioned HCFL lighting, using traditional ballasts, by a large margin. (Ballasts and ballasting devices refer to the electronic components necessary to drive a particular type of lamp. Hereinafter we will use “driver circuitry” to describe electronic components necessary to drive a particular type of lamp because “driver circuitry” is simpler and less archaic than the term “ballast”.)

However, cold cathode fluorescent lamps (CCFL) outperform both HCFL and CFL lighting in every category but have not yet been well represented in the marketplace. The advantages of CCFL over the CFL and HCFL are as follows:

1) CCFL lighting is more efficient in terms of lumens per watt than CFL or HCFL lighting;

2). CCFL lamps have a longer lifetime than both CFL and HCFL lamps, a lifetime over 50,000 hours is common;

3) CCFL lamps cost less to manufacture than CFL and HCFL lamps because they are extremely simple;

4) CCFL lamps use significantly less Mercury than CFL and HCFL lamps; and

5) CCFL lighting is inherently easier to dim electronically because there is no hot filament to manage.

Although CCFL lamps do contain small amounts of mercury, which is a known toxic substance, the newer generations of CCFL lamps are made in glass tubes of smaller and smaller diameter. This trend provides three benefits: 1) Higher efficiency, 2) less mercury, and 3) lower cost.

In fact, if electricity that drives the lighting is produced by a coal fired power plant, it turns out that more mercury is released into the atmosphere to drive an incandescent lamp than is used in the manufacture of a CCFL lamp of comparable light output because the amount of electricity needed to drive the incandescent lamp is so much greater than that required to drive the CCFL.

In order to achieve these environmental and economic benefits, CCFL technology should be applied all over the world. The main impediment to using CCFL lighting in home and industrial lighting applications is that existing installations are already wired, socketed, and contain driver circuitry for CFL or HCFL lighting. Therefore, with such a large investment in wiring and sockets the adoption of CCFL lighting products has been slow. Besides this, there are really no commercially available CCFL lighting fixtures available today. CCFL lamps are used extensively for backlighting LCD monitors and TV screens but they are not used often for general purpose lighting.

Therefore, it brooks no delay to invent a lighting device using CCFL lamps as the light emitting device and having a built-in driver circuitry with a form factor to allow it to be placed in existing standard fixtures (T-x lamps in particular) with little or no retrofitting of the existing lighting fixture.

In order to fulfill this need the inventors have made a lighting device that has a built-in driver circuitry. The summary of the present invention is described as follows.

### SUMMARY OF THE INVENTION

The object of the present invention is to provide a lighting device having a built-in driver circuit that may be installed in existing lighting fixtures. The lighting device comprises at least one cold cathode fluorescent lamp (CCFL) and a built-in driver circuit.

For instance, in many offices, there are existing fluorescent lamps (hot cathode) of various shapes (U shaped, straight tubes, circular tubes). Those fluorescent lamps may be removed from the “lighting fixture” and replaced with the present invention. The present invention would look very similar to what was removed because it has to fit in exactly the same space as the fluorescent lamp that it replaced. After all the fluorescent lighting in the office is replaced with the present invention, the office utility bill would be reduced, the office would probably be brighter, and maintenance costs will go down because the lifetime of the present invention is longer than conventional fluorescent lamps.

According to one aspect of the present invention, a lighting device is provided. The lighting device comprises an enclosure, a first printed circuit board (PCB), a second PCB, at least one fluorescent lamp and a driver circuitry.

The enclosure having a first and a second ends.

The first PCB is placed in the enclosure, coupled to the first end of the enclosure and can be any material which can supply a mechanical support and electrical connectivity. The second PCB is placed in the enclosure and coupled to the second end of the enclosure. The fluorescent lamp is placed in the enclosure and having a first electrode and a second electrode.

The driver circuitry is coupled to the first PCB, the first electrode and the second electrode of the fluorescent lamp.

Preferably, the lighting device further comprises a driver circuit and an exterior dimension being of a T-x form factor. For the T-x form factor devices the first end comprises a first pair of conductive pins, and the second end comprises a second pair of conductive pins.

Preferably, the lighting device is directly installed in a fixture for the T-x form factor, wherein the driver circuitry is mounted on the first PCB, and the driver circuitry comprises a control circuit to control a power level of the lighting device.

Preferably, the power level of the lighting device is determined by power supply interruptions that are produced by an action of turning off the power to the lighting device and then turning it back on.

Preferably, the lighting device further comprises an optical feedback circuit so as to adjust the brightness of the fluorescent lamp depending on a brightness of the nearby environment. In this way the light output of the device would change depending on the background light available near the lighting device.

Preferably, the lighting device further comprises a reflector fixed in the enclosure, a power return line and an electrical wire, wherein at least one of the driver circuitry, the power return line and the electrical wire is configured behind the reflector.

Preferably, the fluorescent lamp of the lighting device can be selected from a group consisting of at least one of cold cathode fluorescent lamp (CCFL), an external electrode fluorescent lamp (EEFL) and one carbon nanotube lamp (CNL).

Preferably, the enclosure is comprised of a transparent window and a reflector corresponding to the fluorescent lamp.

According to a second aspect of the present invention, a lighting device is provided. The lighting device comprises a closed tube and a driver circuitry mounted in the closed tube.

Preferably, the lighting device further comprises at least one lighting unit having a first electrode and a second electrode, wherein the closed tube has a first end and a second end. The driver circuitry is mounted near the first end and is electrically coupled to the first and second electrodes.

Preferably, the lighting device is installed in a fixture for T-x form factors, wherein the driver circuitry comprises a control circuit to control a power level of the lighting device.

Preferably, the lighting device is provided, wherein at least one lighting unit is a cold cathode fluorescent lamp (CCFL).

Preferably, the lighting device is provided, wherein the light emitting device is one of an external electrode fluorescent lamp (EEFL) and a carbon nanotube lamp (CNL).

Preferably, the lighting device further comprises a driver circuitry and an exterior dimension being a T-x form factor, wherein for the T-x form factor device the first end comprises a first pair of conductive pins, and the second end comprises a second pair of conductive pins.

According to a third aspect of the present invention, a lighting device is provided. The lighting device comprises an enclosure having at least one end through which a current is delivered into the enclosure; at least one cold cathode fluorescent lamp (CCFL) mounted in the enclosure and having a first and a second electrodes; and a driver circuit mounted in the enclosure and coupled to the first and the second electrodes.

Preferably, the lighting device further comprises a means for providing an electrical power and coupled to at least one end of the enclosure and the driver circuit.

Preferably, the lighting device further comprises a printed circuit board (PCB) configured in the enclosure and coupled to at least one end of the enclosure.

Preferably, the lighting device further comprises a first and a second printed circuit boards (PCBs) configured in the enclosure, the at least one CCFL is mounted on the first and the second PCBs.

Preferably, the lighting device further comprises an exterior dimension being identical to a conventional form factor.

Preferably, the lighting device may be installed in a conventional fixture.

The above objects and advantages of the present invention will become more readily apparent to those ordinarily skilled in the art after reviewing the following detailed descriptions and accompanying drawings, in which:

### BRIEF DESCRIPTIONS OF THE DRAWINGS

FIG. 1 shows a perspective view of the first preferred embodiment of the present invention;

FIG. 2 shows the second preferred embodiment of the present invention;

FIGS. 3 (a) and (b) show the installation of the invention as a replacement for a T-x form factor fluorescent light;

FIGS. 4 (a) and (b) show an abstract view of the third preferred embodiment of the present invention; and

FIGS. 5 (a) and (b) show an electrical schematic of the invention for a single CCFL and dual CCFL application.

### DETAILED DESCRIPTION OF THE PRESENT INVENTION

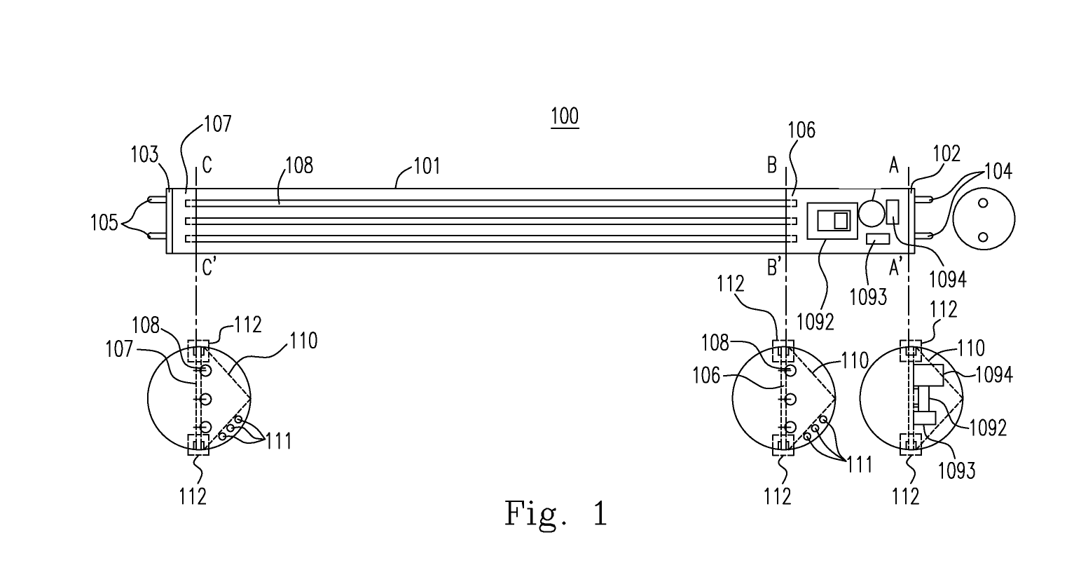

Please refer to FIG. 1, which shows a perspective view of a first preferred embodiment of a lighting device (100) in accordance with the present invention and comprises an enclosure (101), a first printed circuit board (PCB) (106), a second PCB (107), at least one fluorescent lamp (108) and a built-in driver circuitry (1092).

The enclosure (101) has a first end (102) and a second end (103), and may be made of plastic or glass (or any appropriate and applicable materials) with external dimensions as a T-8 (T-x) form factor or any other conventional form factors.

The first end (102) and the second end (103) have a pair of conductive pins (104) and (105) respectively, which allow electricity to flow into the lighting device (100).

The first PCB (106) and a second PCB (107) are coupled respectively to the first end (102) and the second end (103).

At least one fluorescent lamp (108) is placed in the enclosure (101) and has a first electrode and a second electrode coupled to the driver circuitry (1092) respectively.

Referring to the cross-section along the AA′ line in FIG. 1, the driver circuitry (1092) is a module of electronic components and is mounted on the first PCB (106).

Referring to the cross-section along the BB′ line in FIG. 1, the first PCB (106) is placed in slots (112) of the enclosure (101) and the at least one florescent lamp (108) is mounted in the first PCB (106). Current through the florescent lamp (108) is returned (if necessary) to the end of the enclosure (101) containing the built-in driver circuitry (1092) by means of wires (power return lines (111) or any other electrical wires) hidden behind a reflector (110) (fixed in the enclosure (101)) in back of the at least one florescent lamp (108).

The cross-section along the CC′ line in FIG. 1 illustrates the same condition for the second PCB (107). Note that if the number of florescent lamp (108) is two then there may be no reason for power return lines (111) since current traveling through one tube can return to the driver circuitry (1092), through the other tube.

However, the first and second PCBs (106, 107) serve as a support and connection point for the florescent lamp (108). In fact the second PCB (107) is only a support and connection for the florescent lamp (108) and has no electronics. The support and connection function can be provided by some other mechanical construction other than a PCB. A PCB is just one easy way to provide the support and connection function.

The driver circuitry (1092) provides the proper voltage and current for driving a florescent lamp (108) and comprises a control circuit (1093) and an optional optical feedback circuit (1094).

The control circuit (1093) has a capability of running the florescent lamp (108) at power levels less than full power whereby that the power level is selected by interpreting short power interruptions on supply lines to the florescent lamp (108), wherein such power supply interruptions are produced by an action of momentarily turning the power off and then on again.

The optical feedback circuit (1094) can also be included in the embodiment and used for accurately monitoring ambient light and controlling the actual luminance of the florescent lamp (108), in this way the illumination in the room would stay constant even though another source of room light (such as sunlight) might be changing throughout the day.

However, the driver circuitry (1092) might perform more advanced functions such as dimming, wireless control, ambient light sensing etc.

The at least one florescent lamp (108) can be a Cold Cathode Fluorescent Lamp (CCFL), an External Electrode Fluorescent Lamps (EEFL), Carbon Nanotube Lamps (CNL) or any other applicable type. Note that the driver circuitry (1092), the control circuit (1093), the optical feedback circuit (1094) or any other circuitry can be configured behind the reflector (110) instead of at one end of the tube. By placing the driver circuitry (1092), the control circuit (1093) and the optical feedback circuit (1094) behind the reflector (110) of the florescent lamp (108) can exist along the entire length of the enclosure (101) maximizing the light output area.

The idea of the present invention is to put both the driver circuitry (1092) and the florescent lamp (108) into a package that has the same exterior dimensions as a standard T-8 fluorescent lamp or the T-x numbers (such as T-1, T-2, T-3 and etc). In order to install the present invention in existing light fixtures, the original fixture's driver circuitry, may need to be bypassed so that the line voltage is available to the power input pins of the invention. In this way the internal electronics inside the invention use the line voltage to provide drive for the florescent lamp (108).

If the existing fixtures use traditional driver circuitry (traditional driver circuits, “ballasts”, are usually just big inductors) then removing the existing starter from the lighting fixtures and replacing the old fluorescent lighting with the present invention is all that is required.

If the existing lighting fixtures have electronic driver circuitry then those electronic driver circuits will need to be bypassed.

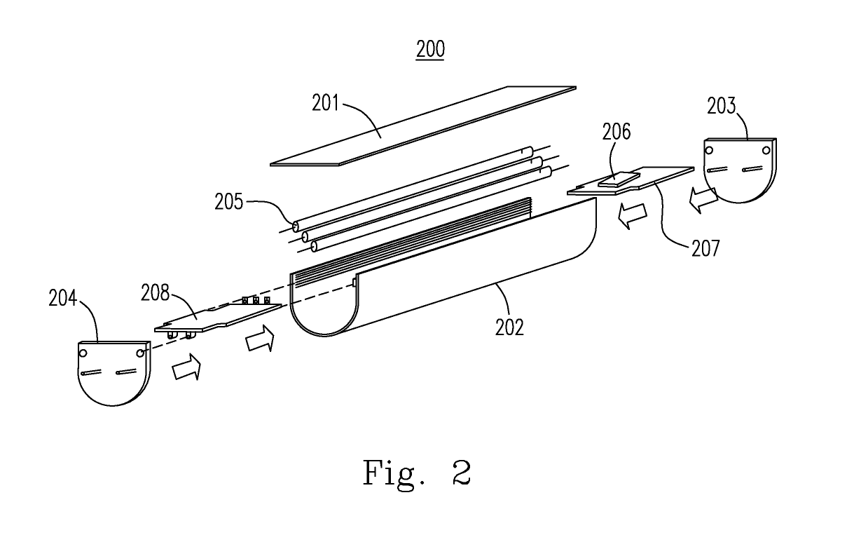

Please refer to FIG. 2, which shows the second preferred embodiment of a lighting device (200) in accordance with the present invention. The lighting device (200) has a general shape of T-x lighting but with a U shaped cross section. The lighting device (200) comprises an enclosure, at least one florescent lamp (205), a driver circuitry (206), a first PCB (207) and a second PCB (208)

The enclosure comprises a transparent window (201), a U shaped reflector (202) and a first end (203) and second end (204) that each end has a pair of conductive pins respectively. At least one florescent lamp (205) is coupled to a driver circuitry (206) that is coupled to the first end (203).

The second PCB (208) is coupled to the second end (204) and the first PCB (207) coupled to the driver circuitry (206). The driver circuitry (206) is mounted on one end of the enclosure and the second PCB (208) served as a support and connection point for the florescent lamps (205).

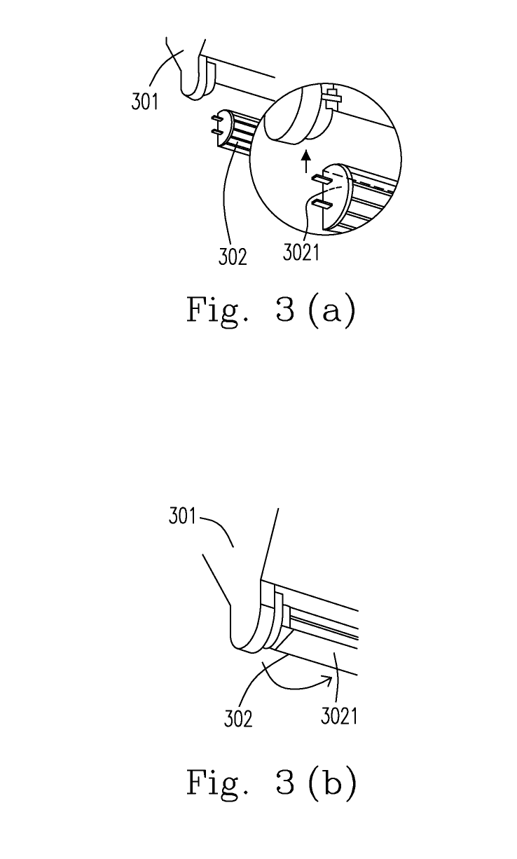

Please refer to FIGS. 3 (a) and (b), which shows the installation of a lighting device (302) in accordance with the present invention into a standard T-x fixture.

The installation comprises the steps of

(a) turning off the device switch;

(b) removing the starter (white cylindrical can) from the original fixture;

(c) placing a lighting device (302) of the present invention into an original fixture (301); and

(d) twisting the lighting device (302) of the present invention 90 degrees so that the transparent window (3021) is pointing away from the fixture (301).

If the lighting device (302) will not twist in the proper direction then replace it into the fixture (301) oriented 180 degrees opposite from the way that was first attempted, then try the 90 degrees twist again.

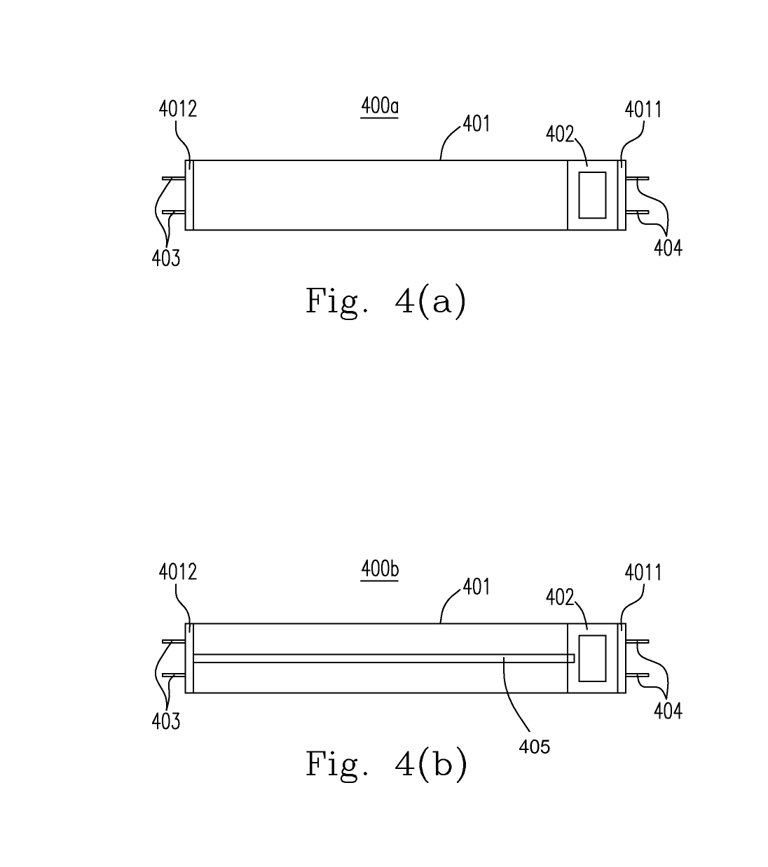

Please refer to FIGS. 4 (a) and (b), which show an abstract view of the third and fourth preferred embodiment (400a, 400b) of the present invention respectively. The third embodiment (400a) comprises a closed tube (401) having a first end (4011) and a second end (4012), and a driver circuitry (402) mounted in the closed tube (401).

The third embodiment (400a) further has an exterior dimension being one selected from a group consisting of a T-8 form factor, a T-x form factor and some other conventional form factors. Any sort of lighting unit can be configured in the embodiment (400a).

A florescent lamp (403) in accordance with the present invention is configured into the third embodiment (400a) to form the embodiment (400b). The florescent lamp (405) is coupled to the drive circuitry (402) and mechanically coupled to the second end (4012). The florescent lamp (405) has both of its ends electrically coupled to the driver circuitry (402), and may be a Cold Cathode Fluorescent Lamp (CCFL), an External Electrode Fluorescent Lamps (EEFL) or Carbon Nanotube Lamps (CNL).

In addition, the fourth embodiment (400b) has two pairs of conductive pins (403) (404) so that the fourth embodiment (400b) can be directly installed into an existing T-x fixture.

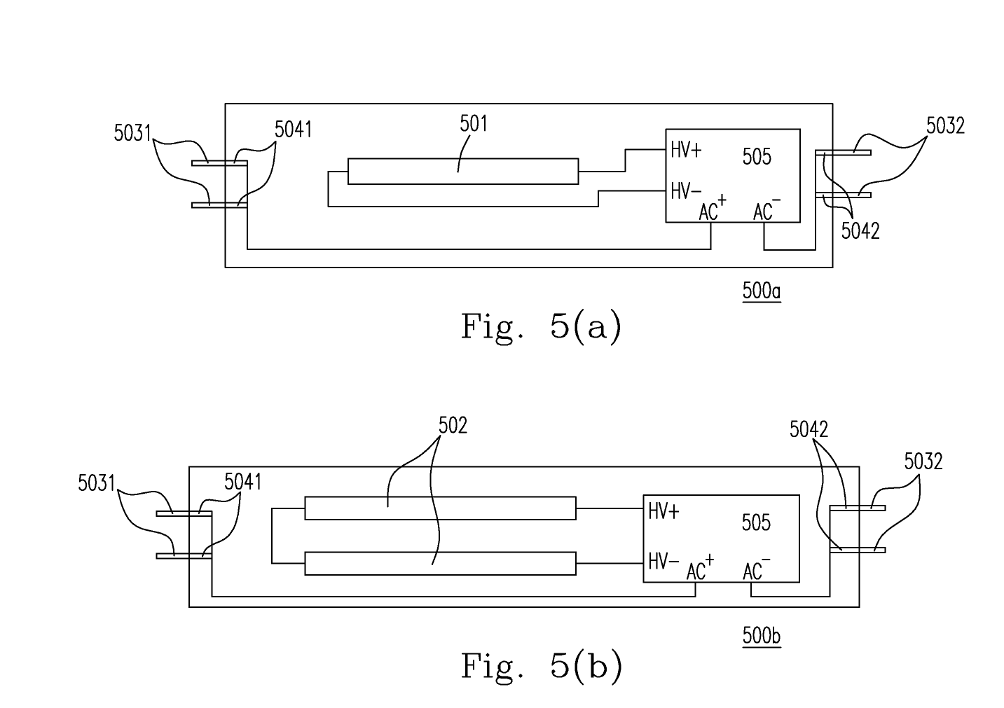

FIG. 5(a) shows an electrical schematic of a single lamp (501) T-x form factor application. FIG. 5(b) shows how a dual lamp (502) application would be wired. Both single lamp (501) T-x form factor and a dual lamp (502) application have external pins (5031) and (5032) on both ends and are respectively shorted to internal pins (5041) and (5042) on the same end.

The external pins (5031) and (5032) at the ends of the enclosure provide AC power from an external power source to a driver circuitry (505). The driver circuitry (505) then converts the AC power into a high voltage—high frequency signal compatible with florescent lamp technology such as CCFL technology. However, for other lamp technologies, such as EEFL or CNL technology, the driver circuitry (505) must be tailored to those particular technologies.

The virtue of using a lighting device having a built-in driver circuitry of the present invention is that a CCFL or other sort of ultra efficient lighting device can be installed into an existing fixture without retrofitting for the new lighting technology.

Therefore, there is no need to make a large investment in wiring and sockets in order to adopt efficient CCFL lighting products. Wide use of the invention with CCFL (or other efficient lighting technologies) can benefit people and the earth enormously.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures.

Therefore, the above description and illustration should not be taken as limiting the scope of the present invention which is defined by the appended claims.

People skilled in the art will understand that various changes, modifications, and alterations in form and details may be made without departing from the spirit and scope of the invention.

What is claimed is:

1. A lighting device, comprising
an enclosure having a first end and a second end;
a first material being fixed in the enclosure and coupled to the first end;
a second material being fixed in the enclosure and coupled to the second end;
at least one fluorescent lamp having a first electrode and a second electrode; and
a driver circuitry being coupled to the first material, the first electrode and the second electrode.

2. The lighting device as claimed in claim 1, wherein the first material and the second material are a first printed circuit board (PCB) and a second PCB respectively, which supply a mechanical support and an electrical connectivity.

3. The lighting device as claimed in claim 1, wherein the driver circuitry is an electronic ballast.

4. The lighting device as claimed in claim 1, wherein the at least one fluorescent lamp is selected from a group consisting of a cold cathode fluorescent lamp, an external electrode fluorescent lamp and a carbon nanotube lamp.

5. The lighting device as claimed in claim 2, wherein the at least one fluorescent lamp is mounted on the first PCB and the second PCB.

6. The lighting device as claimed in claim 2, wherein the enclosure comprises a transparent window and a reflector.

7. The lighting device as claimed in claim 2, further comprising an exterior dimension of a T-x form factor, wherein the first end comprises a first pair of conductive pins and the second end comprises a second pair of conductive pins.

8. The lighting device as claimed in claim 6, further comprising at least one power return line and at least one electrical wire, wherein the power return line, the electrical wire and the driver circuitry is configured behind the reflector.

9. The lighting device as claimed in claim 7, wherein the driver circuitry comprises a control circuit to control a power level of the lighting device.

10. The lighting device as claimed in claim 7, the lighting device being installed in a fixture for the T-x form factor, wherein the driver circuitry is constructed on one of the first and second PCBs.

11. The lighting device as claimed in claim 7, wherein the driver circuitry further comprises an optical feedback circuit to adjust a brightness of the florescent lamp based on a brightness of a surrounding environment.

12. The lighting device as claimed in claim 9, wherein the power level being determined by power supply interruptions that is produced by an action of turning the power of the lighting device on and off.

13. A lighting device, comprising
an enclosure having at least one end, and current is delivered into the enclosure through at least one end;
at least one fluorescent lamp being mounted in the enclosure and having a first electrode and a second electrode; and
a driver circuitry being mounted in the enclosure and coupled the first electrode and the second electrode.

14. The lighting device as claimed in claim 13, further comprising a means for providing an electrical power and coupled to the driver circuitry.

15. The lighting device as claimed in claim 13, further comprising a first PCB and a second PCB, wherein the first and second PCB is configured respectively in the enclosure and coupled to at least one end.

16. The lighting device as claimed in claim 13, further comprising an exterior dimension being identical to a conventional form factor.

17. The lighting device as claimed in claim 16, the lighting device comprising an exterior dimension being identical to a conventional form factor.

18. The lighting device as claimed in claim 15, wherein the at least one fluorescent lamp is connected to the first PCB and the second PCB.
